(19) United States
(12) Patent Application Publication
(10) Pub. No.: US 2011/0304267 A1
(43) Pub. Date: Dec. 15, 2011

(54) Noble Gas Short-Arc Discharge Lamp

(75) Inventors: Christoforos KAZAZIS, Ingolstadt (DE); Wolfgang Seitz, Eichstaett (DE)

(73) Assignee: OSRAM Gesellschaft mit beschrankter, Munich (DE)

(21) Appl. No.: 13/100,040

(22) Filed: May 3, 2011

(30) Foreign Application Priority Data
May 3, 2010 (DE) 10 2010 028 472.6

(51) Int. Cl. H01J 61/16

(52) U.S. Cl. 313/643

(57) ABSTRACT

A noble gas short-arc discharge lamp (1) comprising a discharge vessel and electrodes (2, 3) arranged therein is disclosed. The discharge vessel, for the purpose of thermal insulation, has at least in sections a coating (8) serving for reflecting infrared radiation.

### RELATED APPLICATIONS

This application claims the priority of German patent application no. 10 2010 028 472.6 filed May 3, 2010, the entire content of which is hereby incorporated by reference.

### FIELD OF THE INVENTION

The invention is related to a noble gas short-arc discharge lamps comprising a discharge vessel and electrodes arranged therein.

The term noble gas short-arc discharge lamp here designates short-arc discharge lamps comprising a discharge vessel composed of quartz glass which is filled exclusively with a noble gas or noble gas mixture. Lamps of this type are usually operated with DC current or pulsed DC current. Said lamps are suitable for diverse fields of use, in particular also for cinema projection, profile spotlights and searchlights and also microscopy and endoscopy.

### BACKGROUND OF THE INVENTION

As a measure for increasing the luminance of a noble gas short-arc discharge lamp (AC, DC, pulsed operation) it is known in accordance with the prior art to increase for example the pressure in the discharge vessel. In this case, however, the starting behavior of the discharge lamp is altered negatively since the required starting voltage (cold start and hot restart) increases.

The patent specification EP 1 217 644 B1 discloses in FIG. 1 a generic noble gas short-arc discharge lamp with a xenon filling for cinema projection.

### SUMMARY OF THE INVENTION

One object of the present invention is to provide a noble gas short-arc discharge lamp having improved cold starting behavior with the luminance remaining the same or with a luminance that is increased with the cold starting behavior remaining the same.

The noble gas short-arc discharge lamp according to an embodiment of the invention has a discharge vessel and electrodes arranged therein, between which an arc is formed during the operation of the lamp. According to the invention, the discharge vessel has at least in sections a coating for at least partly reflecting the electromagnetic radiation, in particular the infrared (IR) thermal radiation, emitted during operation by the lamp components situated in the discharge vessel and also by the excited filling gas. As a result of the IR radiation back reflection brought about thereby, the wall of the discharge vessel, the filling gas and also those lamp components of the discharge vessel on which the reflected radiation impinges are additionally heated during the operation of the lamp. This leads to an increase in the operating pressure of the filling gas and also to a lengthening of the electrode rods on account of the greater thermal expansion and, consequently, to a shortening of the electrode spacing. Without the IR reflective coating, by contrast, the IR radiation would largely be emitted through the discharge vessel into the surroundings.

These relationships can advantageously be utilized for the following two aims. In this case, the starting point of the following considerations is a conventional reference lamp without an IR reflective coating. If, then, an otherwise structurally identical lamp is provided with the IR reflective coating according to the invention, during operation with the same power consumption, the filling pressure is higher than in the case of the reference lamp, as a result of which the discharge arc contracts to a greater extent. As a result of this and as a result of the shortening of the electrode spacing during operation, a higher luminance is obtained in comparison with the reference lamp.

Alternatively, the increase in the operating pressure of the lamp which arises on account of the heating effect explained above can be utilized to reduce the cold filling pressure of the lamp in such a way that the regular operating pressure of the lamp is established, which would also have been established in the case of normal filling without a heat reflective coating but with the same power consumption. The lower cold filling pressure affords the advantage that the required starting voltage (cold start and hot restart) of the discharge lamp is lower than in the case of the reference lamp. At the same time, however, on account of the IR reflective coating, the filling pressure during operation and hence the luminance is the same as in the case of the reference lamp.

Particularly good reflection properties in the infrared spectral range and thus optimized thermal insulation of the noble gas short-arc discharge lamp according to the invention can be achieved if the reflective coating is composed of a layer system comprising a plurality of layers.

Preferably, a layer of the layer system composed of a material having a low refractive index and a layer composed of a material having a high refractive index are respectively alternated.

The layer composed of the material having a low refractive index can comprise a material which consists of an oxide or a nitride or an oxynitride composed of one of the metals Si, Zr, Al, Sn, ZN and of mixtures thereof (for example SiO₂, ZrO₂, Al₂O₃). One preferred material for the layer composed of a material having a low refractive index is SiO₂.

The material of the layer having a high refractive index comprises, for example, a material composed of an oxide or composed of a nitride or composed of an oxynitride composed of one of the metals Nb, Ti, Ta, Hf, and mixtures thereof (for example Nb₂O₅, TiO₂ HfO₂). It has proved to be advantageous to use Nb₂O₅ as a layer.

The layer system has at least 30 and at most 80 layers.

Since, during DC operation of the noble gas short-arc discharge lamp according to the invention, the anode, on account of its size, heats up to a particularly great extent and, accordingly, emits a particularly large amount of heat, it is preferred in accordance with a first exemplary embodiment if a region of the discharge vessel which is adjacent to the anode is coated.

In order to utilize as much as possible of the heat produced in the interior of the noble gas short-arc discharge lamp for increasing the pressure, it is preferred in accordance with another exemplary embodiment if the discharge vessel is substantially or even completely coated. As a result, during operation, the entire discharge vessel can be heated by the infrared-reflecting effect of the coating. However, in this case the layer system should preferably be designed such that it is sufficiently transparent to light.

In one exemplary embodiment, the discharge vessel is filled with pure xenon gas or a xenon-krypton gas mixture.

### BRIEF DESCRIPTION OF THE DRAWINGS

The invention will be explained in greater detail below on the basis of exemplary embodiments. In the figures:

FIG. 1 shows an exemplary embodiment of a xenon short-arc discharge lamp (XBO) comprising a coating according to the invention;

FIG. 2 shows a reflection diagram; and

FIG. 3 shows a further exemplary embodiment of a xenon short-arc discharge lamp.

### DETAILED DESCRIPTION OF THE DRAWINGS

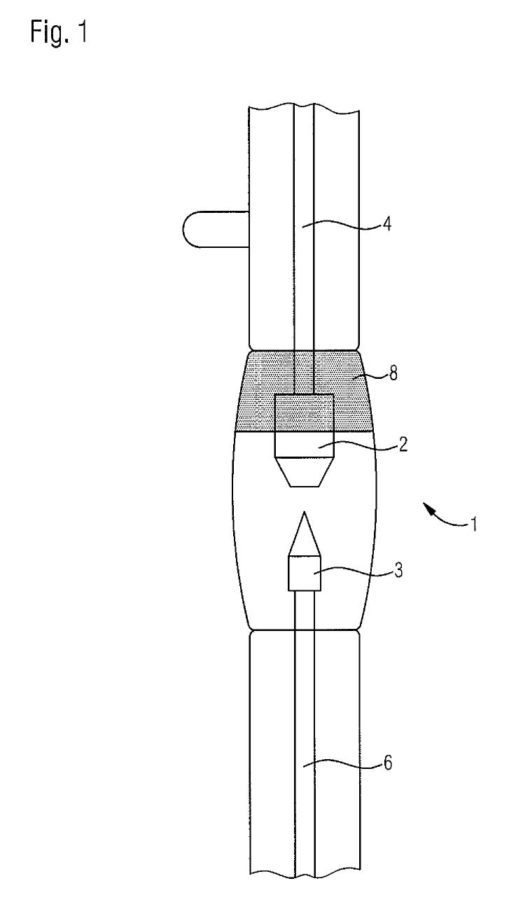

FIG. 1 shows an excerpt from an exemplary embodiment of a noble gas short-arc discharge lamp designed for DC operation (DC) with a power consumption of 450 W in an elevation. The lamp has a discharge vessel 1 consisting of glass, in which an anode 2 and a cathode 3 are arranged in a manner spaced apart from one another. The two electrodes 2, 3 are held in the discharge vessel 1 by means of respective electrode rods 4, 6. For their part, the electrode rods are mounted in the respective end regions of the lamp and led toward the outside in a gas-tight manner in order to be able to be connected to external power supplies (not illustrated). The discharge vessel 1 is filled with pure xenon gas at a cold filling pressure of 10 bar. This corresponds to the cold filling pressure of a conventional 450 W xenon short-arc lamp.

In the region of the anode 2, the outer side of the discharge vessel 1 is provided with a coating 8. In this case, the coating 8 consists alternately of silicon oxide (SiO₂) and of niobium oxide (Nb₂O₅) layers. These layers have refractive indices that deviate significantly from one another.

For operating the noble gas short-arc discharge lamp according to the invention, firstly an arc is struck by means of a comparatively high starting voltage between the two electrodes 2, 3, said arc extending through the xenon gas. The running voltage established after starting between the electrodes is significantly lower than the starting voltage. During operation, infrared thermal radiation arises in the discharge vessel 1 and, in particular, as a result of the hot anode 2, as a result of which the gas pressure increases in the entire discharge vessel 1. The thermal radiation partly impinges on the coating 8 and is substantially reflected back from the latter into the discharge vessel 1. In this case, the coating 8 is substantially transmissive to visible light. As a result of the reflection of the thermal radiation, the interior of the discharge vessel 1 is heated further, as a result of which the operating pressure is increased further. This leads to a constriction (concentration) of the arc and specifically of the point of maximum luminance directly in front of the cathode tip (hot spot), which consequently advantageously increases the luminance of the arc but also the hot spot luminance.

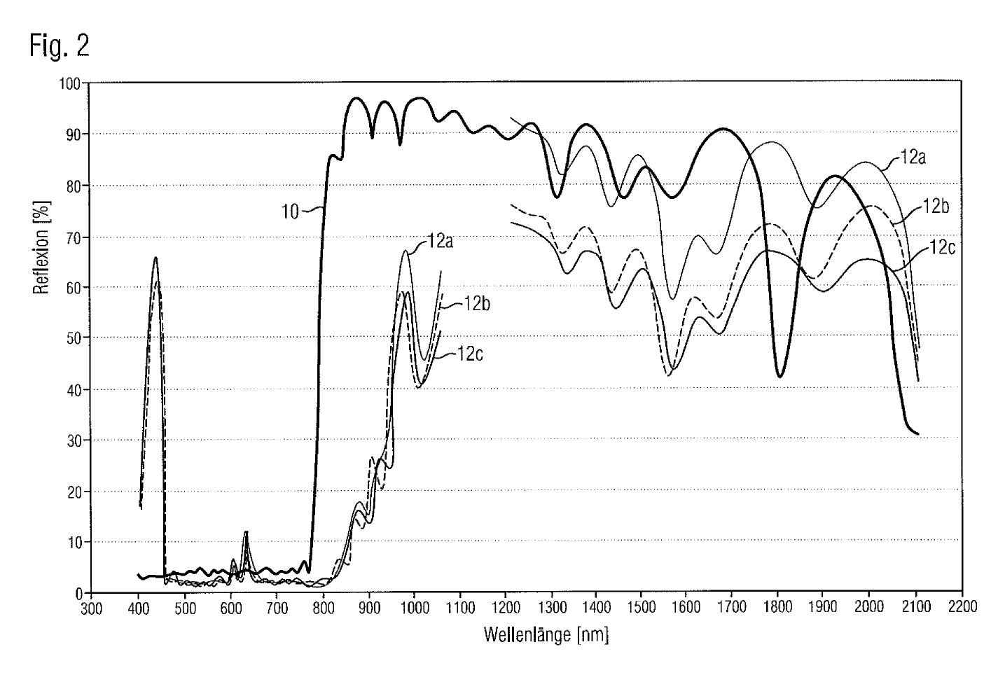

FIG. 2 shows a reflection diagram of the noble gas short-arc discharge lamp. In this case, the percentage proportions of the radiation reflected back into the discharge vessel 1 are plotted against various wavelengths of the radiation emitted by the interior of the noble gas short-arc discharge lamp. The range of visible light of approximately 400 to 700 nm is plotted on the left on the diagram.

A curve 10 depicted comparatively thick represents the desired spectrum of the coating 8 (cf. FIG. 1), while the three different curves 12a, 12b, 12c depicted thinner show the proportion of the reflected radiation at three different exemplary measurement points of the noble gas short-arc discharge lamp coated according to the invention.

In the range of the wavelength from approximately 1050 to approximately 1200 nm, no measurement values are present on account of a measurement range jump of the spectrometer.

The diagram shows low reflection by the coating 8 in the range of visible light, while in the infrared range (up to 2100 nm) the majority of the thermal radiation is reflected back into the discharge vessel 1 by the coating 8.

The infrared-reflecting (IR) coating 8 according to the invention gives rise to an increased operating pressure in the discharge vessel 1 during operation, said pressure leading to a luminance increased by approximately 10% above that of comparable noble gas short-arc discharge lamps (in accordance with the prior art).

In an alternative variant of the above-explained exemplary embodiment of a 450 W xenon short-arc discharge lamp, the cold filling pressure of the discharge vessel is reduced by approximately 10% to approximately 9 bar. As a result, the required starting voltage (cold start and hot restart) of the discharge lamp is reduced by approximately 15%. The technological outlay in respect of apparatus (starting devices, line routing) is decreased as a result. During operation, on account of the IR reflective coating, the gas pressure increases to the operating pressure originally provided for this type of lamp. As a result the luminance obtained in the case of the conventional counterpart without an IR reflective coating is also achieved—despite a reduced cold filling pressure.

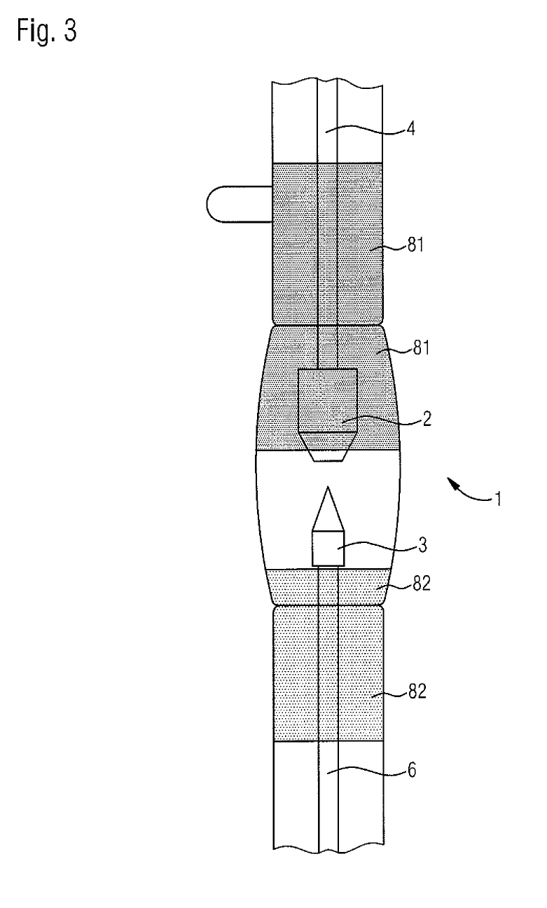

FIG. 3 shows an excerpt from a further exemplary embodiment. A 450 W xenon short-arc discharge lamp 1 is likewise involved. In contrast to the embodiment illustrated in FIG. 1, however, here the IR reflective coating is not restricted to the region of the lamp vessel around the anode 2. Rather, anodally the IR reflective coating 81 extends essentially in the region from the tip of the anode 2 along the anode rod 4. Moreover, cathodally, too, the lamp in FIG. 3 has an IR reflective coating 82 on the outer side of the lamp vessel, said coating extending essentially along the cathode rod 6. What is achieved as a result of the expansion of the IR reflective coating of the lamp vessel to the region of the electrode rods 4, 6 is that IR radiation is also reflected back to the electrode rods 4, 6 and the latter are additionally heated thereby. On account of the additional heating of the electrode rods 4, 6, the latter expand in length, as a result of which the distance between anode 2 and cathode 3 is shortened. The shorter electrode spacing—like the increase in gas pressure already explained above in the case of FIG. 1—likewise contributes to a higher luminance. In this way, an increase in the luminance by approximately 10% is achieved with the aid of the two effects of increasing the operating pressure and electrode rod expansion.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

We claim:

1. A noble gas short-arc discharge lamp comprising a discharge vessel and electrodes arranged therein, wherein the discharge vessel has at least in sections a coating for reflecting infrared radiation.

2. The noble gas short-arc discharge lamp as claimed in claim 1, wherein the coating is transmissive to visible light.

3. The noble gas short-arc discharge lamp as claimed in claim 1, which is a high-pressure or ultra-high-pressure noble gas short-arc discharge lamp.

4. The noble gas short-arc discharge lamp as claimed in claim 1, wherein the coating has a plurality of layers.

5. The noble gas short-arc discharge lamp as claimed in claim 1, wherein the coating has 37 to 80 layers.

6. The noble gas short-arc discharge lamp as claimed in claim 5, wherein the layers alternatively comprise silicon oxide and niobium oxide.

7. The noble gas short-arc discharge lamp as claimed in claim 1, wherein the coating is fitted to the discharge vessel in a manner adjacent to an anode.

8. The noble gas short-arc discharge lamp as claimed in claim 1, wherein the discharge vessel is substantially or completely coated.

9. The noble gas short-arc discharge lamp as claimed in claim 1, wherein the discharge vessel is filled with pure xenon gas.
